(19) United States
(12) Patent Application Publication
(10) Pub. No.: US 2016/0224842 A1
(43) Pub. Date: Aug. 4, 2016

(54) METHOD AND APPARATUS FOR AERIAL SURVEILLANCE AND TARGETING

(71) Applicant: RAFAEL ADVANCED DEFENSE SYSTEMS LTD., Haifa (IL)

(72) Inventors: Israel Greenfeld, Kfar Vradim (IL); Zvi Yavin, Gilon-Msgav (IL)

(21) Appl. No.: 15/082,995

(22) Filed: Mar. 28, 2016

Related U.S. Application Data
(63) Continuation-in-part of application No. 14/370,191, filed on Jul. 1, 2014.

(30) Foreign Application Priority Data
Jan. 9, 2012 (IL) 217432

(51) Int. Cl. G06K 9/00; G06T 7/20; B64D 47/00; H04N 7/18

(52) U.S. Cl. CPC G06K 9/00771; H04N 7/181; G06K 9/0063; G06T 7/20; B64D 47/00; G06T 2207/10032; G06T 2207/30232

(57) ABSTRACT

An airborne system for performing surveillance of a stationary or moving object on the ground, comprising:

two independent image-acquiring devices that are mounted at two extremities of a pod, respectively, a first of said image-acquiring devices is a scanning device which is used for scanning an area of interest and identifying targets therein, and the second of said image acquiring devices is an investigation device which is used for investigating one or more of said identified targets.

### FIELD OF THE INVENTION

The invention relates to the field of aerial surveillance and targeting. More particularly, the invention relates to a system and apparatus suitable for performing surveillance over wide areas, when large amounts of image data needs to be analyzed, and for designating selected targets.

### BACKGROUND OF THE INVENTION

Arial surveillance has become of critical importance for security purposes, to locate, identify and understand security threats, and to trace those security threats back to their origin. Many efforts and money have gone into seeking solutions that would permit to monitor large areas for extended periods of time, such as in the “ARGUS-IS” project.

The ARGUS-IS, or the Autonomous Real-Time Ground Ubiquitous Surveillance Imaging System, is a Defense Advanced Research Projects Agency (DARPA) project contracted to BAE Systems. According to DARPA, the mission of the Autonomous Real-time Ground Ubiquitous Surveillance-Imaging System (ARGUS-IS) program is to provide military users a flexible and responsive capability to find, track and monitor events and activities of interest on a continuous basis in areas of interest in day time. The overall objective is to increase situational awareness and understanding enabling an ability to find and fix critical events in a large area in enough time to influence events. ARGUS-IS provides military users an “eyes-on” persistent wide area surveillance capability to support tactical users in a dynamic battlespace or urban environment. The three principal components of the ARGUS-IS are a 1.8 Gigapixels video Focal Plane array (FPA) plus two processing subsystems, one in the air and the other located on the ground. This system is architected around a single gimbal set (referred to hereinafter as: “head”) that moves and stabilizes a single Line Of Sight (LOS) having a symmetrical Field Of View (FOV). Unfortunately, in many cases the area to be monitored has a complex shape (for example when applied for border control) or few separated areas. Accordingly, a single LOS with preshaped FOV configuration results in an inefficient area coverage.

Furthermore, FPAs for night vision are much smaller due to technology limitations. Therefore night vision large FPA configuration will cover less area with less resolution.

While, in principle, systems of the type described above could provide at least a partial solution to the problem, they in fact generate a new problem that makes them difficult to exploit, inasmuch as the amount of processing and data communication needed to analyze high-resolution images is extremely high, requires extremely high computational powers and slows down processing, resulting in low performance. On the other hand, it is not possible to avoid using high-resolution images because of the need to clearly identify objects on the ground and relate them to potential threats.

It is therefore clear that it would be highly desirable to be able to overcome the aforementioned drawbacks and provide a system and method that would be capable of following the movements of an object or individual associated with a potential threat, while avoiding the need to apply too high computational power and while maintaining a performance of practical value for surveillance purposes.

There is therefore a need for a reconnaissance pod that can perform detection task as well as identification task of moving targets during day and night in a large area having a complex shape without resorting to large FPAs, large number of pixels and consequently complicated communication hardware.

Current airborne military operations involve a long cycle consisting of surveillance, reconnaissance, and targeting, typically performed sequentially by several airborne systems, which for moving targets is sometimes too long, resulting in loosing the target. Furthermore, a single airborne targeting system can handle only a single target at a given time.

Therefore, there is a need for fast closing of the long operational cycle consisting of surveillance, reconnaissance, and targeting, so that an object of military value can be targeted a short time after its detection and identification, either by the same system or by another system, and so that a large amount of such objects can be targeted in parallel by a single system.

It is an object of the present invention to provide such a system and method, which overcome the drawbacks and limitations of the prior art.

It is another object of the invention to provide a device useful for carrying out the method of invention.

Other objects and advantages of the invention will become apparent as the description proceeds.

### SUMMARY OF THE INVENTION

An airborne system for performing surveillance of a stationary or moving object on the ground, comprising:

two independent image-acquiring devices that are mounted at two extremities of a pod, respectively, a first of said image-acquiring devices is a scanning device which is used for scanning an area of interest and identifying targets therein, and the second of said image acquiring devices is an investigation device which is used for investigating one or several of said identified targets.

In an embodiment of the invention, said scanning device is of a lower resolution than said investigation device.

In an embodiment of the invention, said investigation involves obtaining for each identified target a respective meta-data.

In an embodiment of the invention, wherein said meta-data includes the target velocity vector, the target image, the range to the target, the target 3-dimentional coordinates, and the airborne platform location and attitude, or a subset of these parameters.

In an embodiment of the invention, said target velocity is calculated from the image stream of the investigation video, including assessment of the target's expected trajectory

In an embodiment of the invention, said investigation involves periodical visiting of each identified target to update and expand said meta data parameters.

In an embodiment of the invention, said scanning device comprises an imaging sensor or a set of imaging sensors that are sensitive to radiation in different spectral ranges.

In an embodiment of the invention, said investigation device comprises an imaging sensor or a set of imaging sensors that are sensitive to light in different spectral ranges.

In an embodiment of the invention, each image-acquiring device comprises at least one focal plane array sensor.

In an embodiment of the invention, said investigation device allows imaging magnification of a target, thereby obtaining higher resolution imagery of the target.

In an embodiment of the invention, investigations of several targets is carried out, either manually or automatically, and handled accordingly.

In an embodiment of the invention, the target imagery, coordinates and other pertinent meta-data that are obtained as a result of the investigation are conveyed to an external system, whether on the same airborne platform or on another platform.

In an embodiment of the invention, said external system uses said meta-data for targeting purposes,

In an embodiment of the invention, said scanning device and said investigation device are identical in terms of their structure, sensors and capabilities.

In an embodiment of the invention, said two identical devices swap their tasks between scanning and investigation.

In an embodiment of the invention, said task swapping involves switching imaging fields of view, namely, alternating between a large field of view with a low resolution and a small field of view with a high resolution.

In an embodiment of the invention, both of said devices perform a same type of task, simultaneously, namely either scanning or investigation.

In an embodiment of the invention, both of said devices are operated and/or controlled separately and independently, capturing and investigating imagery from two different areas of interest.

In an embodiment of the invention, one or both of said scanning and investigation devices are provided with a laser designator, exclusively or in addition to imaging sensors.

In an embodiment of the invention, said laser designator is used for designation of a respective target for the purpose of targeting, or is used to find a range to the target, said targeting involves directing a laser guided munition launched by the same or another airborne platform.

In an embodiment of the invention, when laser designators are provided at both image-acquiring devices, they are controlled separately and simultaneously for the purpose of targeting two different targets at a same time.

In an embodiment of the invention, when said laser designator engages a target, said another image-acquiring device keeps scanning and/or investigating another area of interest at the same time.

In an embodiment of the invention, the investigation device also generates views of the target captured from different angles, using imagery and inertial data that are gathered on the target.

### BRIEF DESCRIPTION OF THE DRAWINGS

In the drawings:

FIG. 1 is a schematic description of the data acquisition and handling process;

FIG. 2 is a side view of a device (referred to throughout this specification as “pod”), according to one embodiment of the invention;

FIG. 3 is a prior art device described in U.S. Pat. No. 7,126,726;

FIG. 4 is a rotated perspective view of the device of FIG. 2;

FIG. 5 is a view of the device of FIG. 2, with its outer cover partially removed; and

FIG. 6 is a schematic illustration of an exemplary image-acquiring procedure according to one embodiment of the invention.

### DETAILED DESCRIPTION OF THE INVENTION

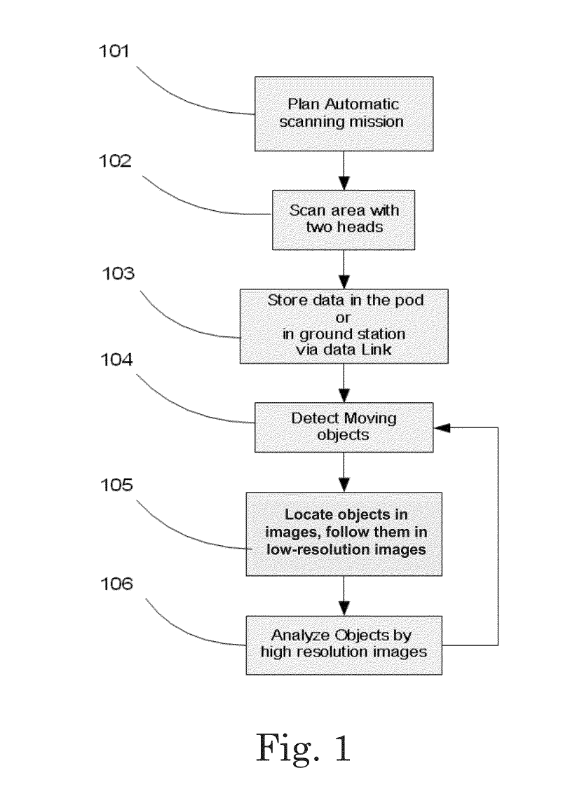

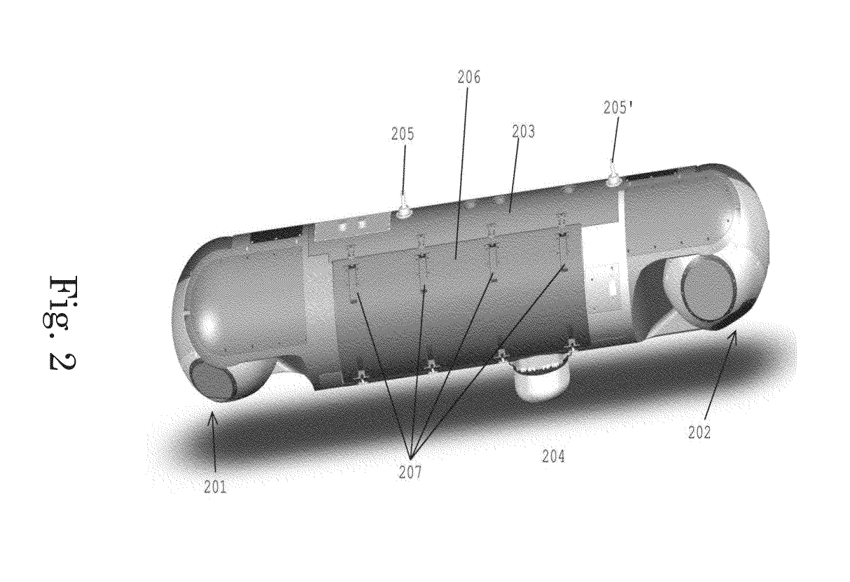

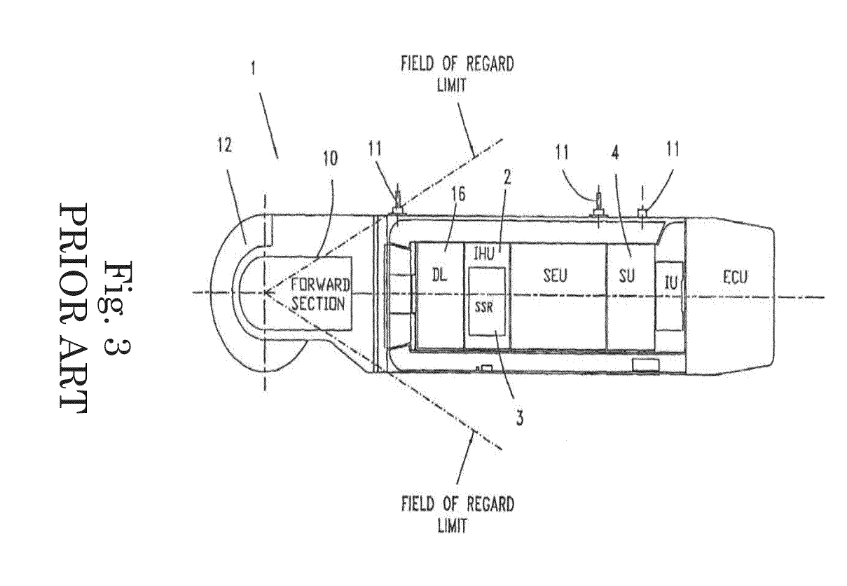

The invention will now be described with reference to a particular embodiment. Image acquisition can be effective, e.g., using the “step and stare” method described in U.S. Pat. No. 7,126,726, the description of which is incorporated herein by reference. The device according to this embodiment of the invention is pod 200 of FIG. 2. This pod is constructed on the basis of the pod described in U.S. Pat. No. 7,126,726 with reference to its FIG. 1, which is reproduced herein as FIG. 3. While the prior art device has a single optical “head”, mounted in its forward section, the device according to one embodiment of the invention has two gimbal-mounted heads 201 and 202, which are located at two extremities of tubular body 203, and together with it constitute the so-called “pod”. Other elements, such as antenna 204 and connectors 205 and 205′ are known in the art, e.g. from U.S. Pat. No. 7,126,726, and therefore are not described herein in detail, for the sake of brevity. Also a hatch 206 is shown, which is closed by latches 207, and which is used to access internal parts of the pod. As will be apparent to the skilled person the tubular section 203 of the pod houses a variety of components, ranging from processing units, communication devices, mechanical elements and motors to drive the gimbals, optional cooling devices, etc. All those elements are understood by, and known to the skilled person and therefore they are not described herein in detail, for the sake of brevity.

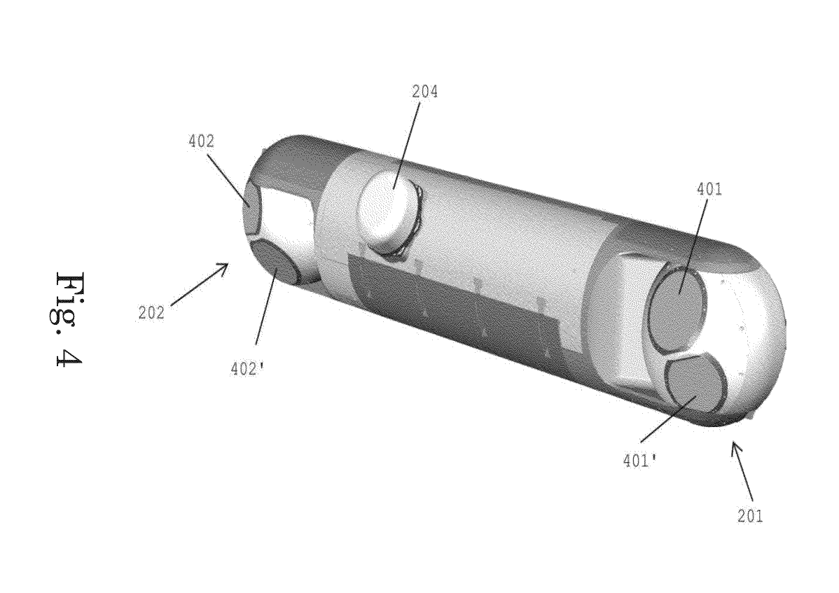

As can be seen from FIG. 4, more than one optical window can be provided in each optical head, e.g., to accommodate different types of imaging devices or for any other purpose. In the illustrative device of the figure each head has two optical windows, indicated by 401 and 401′, and by 402 and 402′.

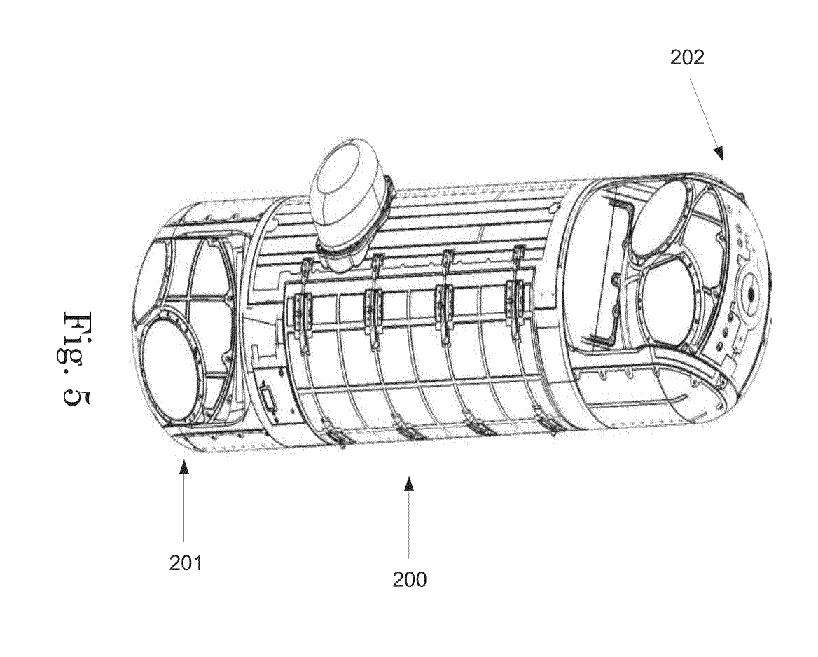

FIG. 5 shows the device of FIGS. 2 and 4 with some covering removed, to further illustrate the relationship of heads 201 and 202 to the remaining parts of the pod.

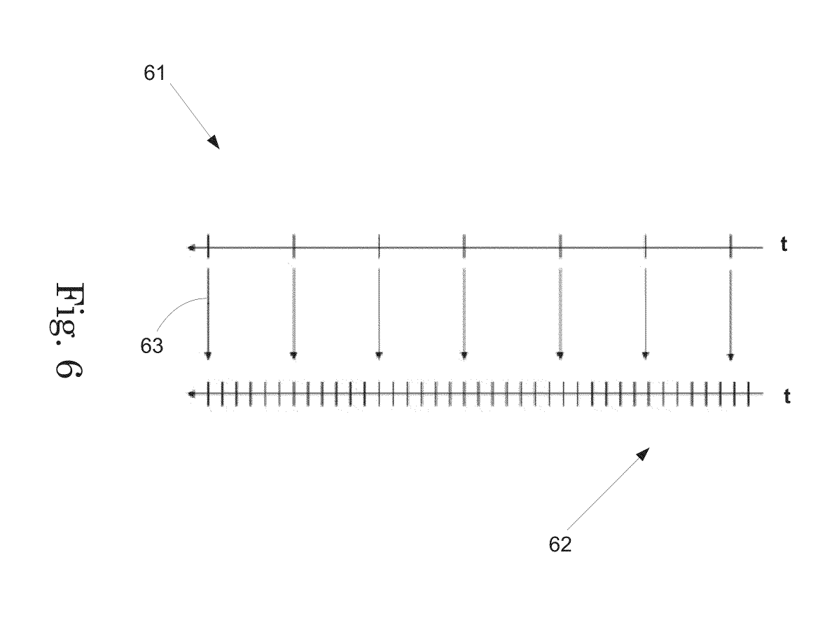

The following illustrative example will assist in better understanding the invention. Referring to FIG. 6, an image acquisition scheme according to one embodiment of the invention is schematically shown, which refers to a situation in which the acquiring aircraft is continuously circling above or in the proximity of the area that is being monitored, or in stand off, and acquiring images. FIG. 6 refers to one cycle of image acquisition. In the figure numeral 61 indicates the time axis for the acquisition of the high resolution images, and 62 that for the low resolution images. When, rather than scanning the whole area of interest at high resolution, investigation of only selected objects is desired, the image capturing rate of these objects will by increased significantly with respect to the rate presented in 61.

As will be apparent to the skilled person, each image has metadata attached to it, such as the time the image was acquired and its GPS or other location information, which can be used to analyze an event that has taken place in the monitored area.

The size of the FPA is predetermined on the basis of engineering and availability considerations. The FPA can be used to image a large FOV thereby covering a large area. However, this comes at the expense of low resolution since the footprint of every pixel on the ground is large. On the other hand, using the FPA to image a narrow FOV enables a high resolution identification of objects at the expense of low area coverage. For instance, if the resolution rate between the low- and high-resolution sensors is 1:3, if they acquire images at the same rate (i.e., the same number of pictures is taken by both per second), the high-resolution sensor will complete a full imaging of the monitored area 9 times slower than the low-resolution sensor. In other words, by the time that the high-resolution sensor has acquired a complete high-resolution image of the area, the low-resolution sensor will have completed this task 9 times.

It is important to note that high and low resolutions are relative terms dictated by object size and details to be observed.

When operating using the pod described in the embodiment of FIGS. 2,4,5 in most practical scenarios, one head scans a given area routinely using a Wide FOV, and the other head scans the same area using a Narrow FOV. This combination enables high scanning rates, using Wide FOV, on one hand, and simultaneously high resolution imagery of the same area (at lower rate), using Narrow FOV.

Referring now back to FIG. 1, the stages of the process according to an embodiment of the invention are schematically shown. Said stages comprise:

a. 101—an automatic scanning mission is planned so the pod is able to scan the designated area, as described in U.S. Pat. No. 7,136,726, both for the head that is taking low resolution images and the one that is taking high-resolution images;
b. 102—the aircraft on which the pod is mounted flies through the area to be scanned. Since the Wide FOV can cover the same area with much smaller number of frames, the pod scans the specified area continuously with low-resolution in high rate, and with high-resolution in lower rate. When the specified area can be covered by a single frame of the wide FOV (low resolution sensor), the line of sight of the wide FOV will obviously stare continuously on it, in which case step 102 will read “stare with wide FOV and scan with narrow FOV”, instead of “Scan area with two heads”.
c. 103—data is sent from the acquisition, optical heads either to the pod itself or to a remote platform. Image processing algorithms can operate either in the pod itself, and thus provide near real-time results, or in a land station. A land station can perform image processing and analysis near real-time, after receiving the data from the pod via a communication line, or alternatively the whole image processing and analysis can be performed off-line after the scanning and image acquisition mission is completed. Which option to choose will depend on the specific requirements of a mission, as well as on the hardware made available to the pod;
d. 104—the images are analyzed continuously in the mode that has been chosen;
e. 105—a detected object is located in the low-resolution images. After the object is located its movement is traced in the high rate string of low-resolution images.
f. 106—the tracked object details are analyzed in the high resolution images.

The process of detection, tracking and analysis can be performed continuously in order to monitor any relevant event. Image processing and analysis can be performed in near real-time in the pod or by a land station after receiving the data from the pod via a communication line. Alternatively, the whole image processing and analysis can be performed off-line after the scanning and image acquisition mission is completed. Which option to choose will depend on the specific requirements of a mission, as well as on the hardware made available to the pod;

As will be apparent to the skilled person, although the double-headed pod described above is a most convenient, novel device for carrying out the invention, it is not necessary to provide imaging heads in the same device, and they can be physically separated into autonomous imaging devices or pods. Moreover, they don't need to be located on the same optical axis and one can be located, for instance, on a pod like the one of U.S. Pat. No. 7,136,726, and the other can be connected to the bottom of the aircraft. Appropriate use of the gimbals will provide for the correct orientation of the imaging sensors at all times.

It should also be emphasized that the above described double-headed pod presents additional advantages, inasmuch as it can be used for a variety of purposes. For instance, the device can be used to perform two separate scanning missions at the same time, as well as to allow two different operators to monitor two different areas or paths at the same time.

From the hardware point of view the two heads can be identical or different, inasmuch as an imaging sensor capable of acquiring high-resolution images can be operated at a lower resolution.

In an embodiment of the invention, two independent image-acquisition devices are mounted at the two extremities of a single airborne pod, respectively, for performing area scanning and target investigation. A first of said image acquisition devices (hereinafter, the “scanning device”) is used for scanning an area of interest and identifying objects of interest. The scanning is performed by a sensor or a set of imaging sensors, whether focal plane arrays or otherwise, that are sensitive to radiation in different spectral ranges.

The second of said image acquisition devices (hereinafter, the “investigating device”) is used for investigating targets that the scanning device identifies. The investigation is performed by a sensor or a set of imaging sensors, whether focal plane arrays or otherwise, that are sensitive to radiation in different spectral ranges.

The investigating device allows high magnification of the image of the object of interest, hence a higher resolution and sensitivity are typically required. Preferably, the investigating device provides a live video imaging of the object.

The investigation process determines whether one or several identified objects are of specific interest (military or otherwise). Based on this assessment, the system determines (manually or automatically) whether to keep handling (i.e., tracking and investigation) one or more of these objects or not. In this process the system extracts meta-data from each selected target In an embodiment of the invention, the investigating device periodically visits each selected target, while expanding its meta-data on each such target.

In one example, the investigating procedure calculates the position (coordinates) of each selected target based on the respective object captured imagery and the available inertial data (GPS or other location information), performs a range sensing/assessment, and it may apply for this purpose a geographical data base that may be located at a ground station or within the pod itself. In addition, the system may calculate a velocity vector for each target, based on its captured video imagery, respectively, and assess the target expected trajectory.

The object's location, velocity and imagery data may be forwarded to external systems or to the airborne platform carrying the pod, for the purpose of targeting.

In one variant of the invention, the two image-acquisition devices at the extremities of the pod are identical, and in that case, each of said devices is capable of performing said two tasks of scanning and investigating. This can be achieved, for example, by switching optical fields of view, thus alternating between a large field of view with low resolution and a small field of view with high resolution. In such a case, the two devices may duplicate, share or alternate tasks. For example, the system may utilize the two image acquisition devices to handle targeting of two targets simultaneously, a significant operational gain.

In still another embodiment, one or more of said two devices at the extremities of the pod contains a laser designator and rangefinder, which is used for designating a target having a military value, thereby to allow direction (by another system or by the same airborne platform carrying the pod) of a laser guided munition towards the target. When the laser designator and range finder is provided within the two devices at the extremities of the pod, the system allows their independent control simultaneously, and therefore the pod is in fact a double-designation targeting pod, enabling the system to engage two targets at the same time. The laser designation characteristic may come in one or more of said two devices in addition to imaging sensors that are in turn used for the purpose scanning and investigation, as described before. Hence, a device which is equipped with both imaging sensors and a laser emitter may alternate its function between an image acquiring device and a targeting device, as well as use its imaging devices to assist the targeting phase.

The investigation process may generate views of a target captured from different angles, using imagery and inertial data gathered on the target, enabling viewing of the target from different directions.

A clarifying example of the application of such a system with scanning and investigation capabilities is for marine surveillance, where a very large sea area can be scanned for the purpose of detecting vessels, which are then individually investigated thoroughly. However, the system is not limited to this scenario, and is intended for both land and marine applications.

All the aforesaid description of a pod according to a preferred embodiment of the invention, as well as of a method to operate a surveillance system, have been provided for the purpose of illustration and are not intended to limit the invention in any way. Many different shapes, arrangements and constructions of the two image acquiring heads can be devised, and many different arrangements and communications between the image-acquisition devices and a remote land station can be provided as readily appreciated by persons skilled in the art, without exceeding the scope of the claims.

1. An airborne system for performing surveillance of an object on the ground, comprising:
two independent image-acquiring devices that are mounted at two extremities of a pod, respectively, a first of said image-acquiring devices is a scanning device which is configured to scan an area of interest and to identify targets therein, and the second of said image acquiring devices is an investigation device which is configured to investigate one or several of said identified targets.

2. A system according to claim 1, wherein said scanning device is of a lower resolution than said investigation device.

3. A system according to claim 1, wherein said investigation device is configured to obtain for each identified target a respective meta-data.

4. A system according to claim 3, wherein said meta-data includes the target velocity vector, the target image, the range to the target, the target 3-dimentional coordinates, and the airborne platform location and attitude, or a subset of these parameters.

5. A system according to claim 4 wherein said target velocity is calculated from the image stream of the investigation video, including assessment the expected trajectory of the target.

6. A system according to claim 1, wherein said investigation device is configured to periodically visit each identified target to update and expand said meta data parameters.

7. A system according to claim 1, wherein said scanning device comprises an imaging sensor or a set of imaging sensors that are sensitive to radiation in different spectral ranges.

8. A system according to claim 1, wherein said investigation device comprises an imaging sensor or a set of imaging sensors that are sensitive to light in different spectral ranges.

9. A system according to claim 1 wherein each image-acquiring device comprises at least one focal plane array sensor.

10. A system according to claim 1, wherein said investigation device is configured to allow imaging magnification of a target, thereby to obtain higher resolution imagery of the target.

11. A system according to claim 1, wherein investigations of several targets are carried out, either manually or automatically, and handled accordingly.

12. A system according to claim 1 wherein the target imagery, coordinates and other pertinent meta-data that are obtained as a result of the investigation are conveyed to an external system, whether on the same airborne platform or on another platform.

13. A system according to claim 12 wherein said external system is configure to use said meta-data for targeting purposes.

14. System according to claim 1 wherein said scanning device and said investigation device are identical in terms of their structure, sensors and capabilities.

15. System according to claim 14, wherein said two identical devices swap their tasks between scanning and investigation.

16. System according to claim 15, wherein said task swapping involves switching imaging fields of view, namely, alternating between a large field of view with a low resolution and a small field of view with a high resolution.

17. System according to claim 1, wherein both of said devices are configured to perform a same type of task, simultaneously, namely either scanning or investigation.

18. System according to claim 1, wherein both of said devices are operated and controlled separately and independently, capturing and/or investigating imagery from two different areas of interest.

19. System according to claim 1, wherein one or both of said scanning and investigation devices are provided with a laser designator, exclusively or in addition to imaging sensors.

20. System according to claim 19, wherein said laser designator is configured to designate a respective target for the purpose of targeting, or is configured to find a range to the target, said targeting involves directing a laser guided munition launched by the same or another airborne platform.

21. System according to claim 19, wherein when laser designators are provided at both image-acquiring devices, they are controlled separately and simultaneously for the purpose of targeting two different targets at a same time.

22. System according to claim 19, wherein when said laser designator engages a target, said another image-acquiring device keeps scanning and/or investigating another area of interest at the same time.

23. System according to claim 1 wherein the investigation device is also configured to generate views of the target captured from different angles, using imagery and inertial data that are gathered on the target.
